(19) United States
(12) Patent Application Publication
(10) Pub. No.: US 2002/0175868 A1
(43) Pub. Date: Nov. 28, 2002

(54) Vehicle antenna arrangement and method of making same

(76) Inventor: Gunter Reichert, Affalterbach (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/098,630

(22) Filed: Mar. 18, 2002

(30) Foreign Application Priority Data
Mar. 16, 2001 (DE) DE 101 13 285.9

(51) Int. Cl. H01Q 1/32

(52) U.S. Cl. 343/713; 343/711

(57) ABSTRACT

In order to maintain the visual quality of the vehicle outer skin of a vehicle while simultaneously increasing the number of antennas integrated in the vehicle outer skin, an antenna arrangement is provided with a number of antennas for different functions and frequencies, the antennas being arranged in/under structural cut-outs in the vehicle outer skin and/or in/under panelling elements to 10H) mounted on the vehicle outer skin.

### BACKGROUND OF THE INVENTION

This application claims the priority of DE 101 13 285.9, filed Mar. 16, 2001, the disclosure of which is expressly incorporated by reference herein.

The invention relates to an antenna arrangement, in particular for a vehicle, having a number of antennas for different functions and frequencies.

Antennas usually have a function of communicating with radio systems and/or mobile telephone systems, with terrestrial or satellite support, with short range communication systems (SRC), or they are part of a vehicle's own systems. With the rising number of communication systems, there is a continuously rising number of radio services which are to be integrated in the vehicle and which require further antennas to be arranged in the vehicle. For example, the following radio services are already integrated, or are still to be integrated, into the vehicle:

| Radio service | Installation location |
|---|---|
| AM | Rear window |
| FM diversity | Rear window |
| TV diversity | Rear window |
| Central locking system | Rear window |
| Mobile telephone | Roof frame |
| GPS | Roof frame |
| Mobile telephone emergency call | Bumper |
| 2nd/nth mobile radio antennas | ? |
| Satellite radio | ? |
| DAB/DMB, ETC, SRC | ? |
| Global star/Orbcom | ? |
| Additional antenna | ? |

In addition to the radio services with wide coverage areas, further radio systems which are inherent in a vehicle and which also require a multiplicity of antennas are known. For example, these are antennas for a distance-determining radar system, for an electronic lock system, for a tire pressure monitoring system, for a telestart system or for a parking aid. In comparison with the abovementioned radio services with wide coverage areas, radio systems which are inherent to a vehicle do not have any connection with the radio service or network which has a wide coverage area.

Furthermore, in particular, the abovementioned short range communication systems are used for locally limited communication, i.e. the radio services which are associated with them do not have a wide coverage area. For example, these are electronic toll collection (ETC) systems, vehicle entry and exit monitoring systems, security and warning systems or what are referred to as vehicle-to-vehicle communication systems which are also limited to the direct vicinity of the vehicle.

Radio and TV antennas are usually embodied in limousines as window antennas in the rear window. These are known, for example, from German Patent Document No. DE 44 06 240 A1. Mobile telephone antennas are usually arranged as short rod antennas at the rear end of the roof or at the upper end of the rear window. Furthermore, U.S. Pat. No. 4,758,166 and German Patent Document No. DE 195 35 250 A1 disclose how antennas are to be integrated and arranged in parts of the bodywork of a vehicle such as the rear tailgate, or roof.

The implementation of further radio services makes it necessary to integrate further antennas in the vehicle. Here, the accommodation of further antennas is associated, if at all possible, with a high degree of expenditure of time and development work. This is due principally to the complex, in some ways mutually contradictory, deployment conditions for different types of antennas in a largely limited space such as that in a vehicle. For example, the number of antennas which are additionally mounted on a vehicle outer skin, such as rod antennas, patch antennas or helix antennas, is limited both for visual and aerodynamic reasons. Furthermore, with such a large number of antennas arranged in a limited space, undesired mutual influences may occur, which have to be suppressed or avoided.

An object of the invention is therefore to specify an antenna arrangement having a number of antennas for different functions and frequencies for a vehicle with a vehicle outer skin, in which the visual quality of the vehicle outer skin is retained while at the same time the number of antennas integrated in the vehicle outer skin rises.

This object is achieved according to the invention by an antenna arrangement having a number of antennas for different functions and frequencies for a vehicle with a vehicle outer skin, the antennas being arranged in structural cut-outs in the vehicle outer skin and/or in panelling elements which are mounted on the vehicle outer skin. By virtue of such an antenna arrangement the best possible aerodynamic properties of a vehicle are obtained while the visual quality of the vehicle outer skin is largely unchanged thanks to the use of already existing attachments or cut-outs for receiving the antennas. As a result of the configuration of the antennas, a good directional characteristic and the highest possible degree of reciprocal decoupling of the antennas is ensured. In particular, the antennas are arranged in a way which is not visible from the outside. Depending on the type and embodiment of the vehicle outer skin, in particular in the case of cut-outs or panelling or bodywork elements which are constructed from plastic, glass or ceramics, the plastic, glass or ceramics serves as a carrier material or as a dielectric for the respective antenna which is to be received. Depending on the type and size of the element and in accordance with the installation space available in the recess, the antenna can be embodied as a line structure or as a module.

At least one of the antennas is expediently arranged in a ventilation opening which is embodied as a cut-out. Furthermore, the cut-outs used are preferably structural ones which were already present in the vehicle outer skin of the bodywork and which are covered or filled with materials which are sufficiently permeable to electromagnetic waves. For example, ventilation openings which have a sufficiently large opening to receive antennas are provided in the engine hood of a vehicle. In a preferred embodiment, covering elements, for example grilles, made of plastic, rubber or glass are provided. These are sealed off from the vehicle outer skin at their edge. Alternatively, or in addition, the break-through or cut-out can be filled with a filling material, for example, resin, the antenna being introduced into the respective material. Here, the filler material is introduced into the vehicle outer skin in the manner of an inlay. In this embodiment, the antenna can be particularly easily protected against soiling or damage. Depending on the type and embodiment, the antenna can be arranged as a prefabricated antenna module or as a line structure in the cut-out itself, in the filler material and/or in the covering element. Here, the covering element or the filler material serves as a carrier for the line structure or as a dielectric of the antennas. In other words, in a preferred embodiment the antennas are integrated in a break-through in particular in an opening which occurs for structural reasons on the vehicle outer skin, or in/under a covering of the break-through or the outer skin of the vehicle or bodywork, which opening is permeable to electromagnetic waves.

At least one of the antennas is advantageously arranged in a cut-out or structure which is due to a joint, in particular in the region of joints of the vehicle outer skin. For example, the antennas are arranged at joints or seams at which individual components of the vehicle outer skin merge with one another. For this purpose, the joint is made correspondingly wide so that a sufficiently large installation space for antennas is provided. Towards the outside, a covering which is permeable to electromagnetic waves can be used to seal off the antennas. This reliably avoids degrading the visual quality of the vehicle outer skin owing to the junctions between the components of the vehicle outer skin which are visible in any case. Preferred junctions in a vehicle are the junctions at the tailgate, the engine hood, the doors, the front or rear window, at the sunroof and the junction between the roof and side wall at which a roof channel is frequently provided.

A further preferred embodiment is obtained in which the cut-out is formed by a slot in the vehicle outer skin. This slot is dimensioned in such a way that a slot antenna is formed. In other words, a slot antenna or aperture antenna can be formed by means of a slot or opening which is suitably dimensioned into the metallic vehicle outer skin directly. The resulting opening can be closed off by means of a covering which is permeable to electromagnetic waves. Joints which are already visible, for example at a gap or a seam between the vehicle roof and the side wall, are preferably to be used.

The panelling element is preferably embodied as an element which is mounted on the vehicle outer skin in a planar fashion. The panelling element is preferably a decorative element, a decorative strip or a ram bar. The decorative element can be, for example, a vehicle make symbol which is mounted on the vehicle outer skin, the antenna being arranged in or under the vehicle make symbol. Alternatively, the element can be mounted in a vertical position on the vehicle outer skin. Depending on the type and embodiment of the decorative element, the antenna is preferably formed by the decorative element itself. For example, the decorative element can be embodied as an annular dipole for radio reception. The decorative element is arranged here in, for example, a planar fashion on the radiator grille or the tailgate or in a vertical position on the engine hood.

The plastic strips which are arranged on the vehicle roof and which protect the vehicle roof against damage by pieces of luggage, serve as a decorative strip or ram strip, for example in an estate car with luggage racks. Furthermore, a roof rack which is formed from plastic can be used for integrating antennas. Depending on the type and embodiment, the panelling element or attachment element is formed from non-conductive material, in particular from plastic, rubber or glass. Here, the attachment element or panelling element serves, depending on the form and embodiment, as a permeable covering, as a carrier, as a dielectric or as some other component of the antenna.

Alternatively, or in addition, a light element which is arranged in the outer region of the vehicle can be designed to hold the antenna by virtue of suitable geometric dimensioning, for example, an additional third brake light at an elevated position between two laterally arranged brake lights is used to hold a slot antenna. For this purpose, the brake light has an opening or a slot which serves as a slot antenna due to its geometric dimensions. Alternatively, or in addition, lateral direction of travel indicators can be used as a slot antenna. Furthermore, other lights, for example headlights, front and/or rear headlights which comprise reflectors made of non-metallic material, can be used to hold an antenna, for example, a reflector antenna.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of an antenna arrangement for a vehicle with antennas arranged in structural cut-outs in the vehicle outer skin, constructed according to preferred embodiments of the invention;

FIG. 2 is a schematic view of an antenna arrangement in panelling elements mounted on the vehicle outer skin constructed according to preferred embodiments of the invention, constructed according to preferred embodiments of the invention;

FIG. 3 is a schematic view of an antenna arrangement in a cut-out in a vehicle due to a joint, constructed according to preferred embodiments of the invention; and

FIG. 4 is a schematic view of an antenna arrangement in a joint, constructed according to preferred embodiments of the invention.

### DETAILED DESCRIPTION OF THE DRAWINGS

Corresponding parts are provided with the same reference symbols in all the figures.

FIG. 1 shows a vehicle 1 with a vehicle outer skin 2 which has structural cut-outs 4 in which a plurality of antennas 6 of an antenna arrangement are arranged. Here, the cut-outs 4 or break-throughs in the metal outer skin 2 or vehicle outer skin 2 of the bodywork provide particularly simple integration, which cannot be seen, or can only be seen to a small degree from the outside, of a number of antennas 6 for different functions and frequencies. For the greatest possible degree of visual quality of the vehicle outer skin 2, the cut-outs 4 are provided with coverings which are permeable to electromagnetic waves. For example the coverings are formed as covering panels made of plastic, glass, ceramics or rubber which are sealed off from the vehicle outer skin 2 at the edge. Alternatively, or in addition, the cut-out 4 can be filled with filler material which is permeable to electromagnetic waves. Here, the antenna 6 can be introduced into the filler material as an antenna module or line structure, said material then being arranged as an inlay in the cut-out 4. Alternatively, or in addition, the antenna 6 can be provided under or in the covering. The covering or the filler material can serve here as a carrier of the line structure or as a dielectric of the antenna 6.

The ventilation openings 4A in the engine hood 8 are preferably used as cut-outs 4 in the vehicle outer skin, the ventilation openings being provided with the covering which is permeable to electromagnetic waves, in particular with a grille. Depending on the type and embodiment, the antenna 6 can be integrated as an inlay in the ventilation opening 4A or in the covering or under the covering.

FIG. 2 shows a further possible way of invisibly integrating the antennas 6. Here, the antennas 6 are arranged in or under attachment parts, in particular panelling elements 10A to 10E. The antennas 6 are preferably arranged in or under panelling elements 10 which are mounted on the vehicle outer skin 2 in a planar fashion. For example a decorative element 10A, for example a vehicle make symbol or a ram strip 10B, a sill trim element 10C, an identifier groove (license plate holder indentation) 10D, or a door trim element 10E are used as the planar panelling elements 10A to 10E. Furthermore, a further decorative element 10A can be arranged in a vertical position on the vehicle outer skin 2, for example as a vehicle make symbol on the engine hood 8. Here, the antenna, for example, an annular dipole, is formed by the decorative element 10A itself. Depending on the embodiment of the decorative element 10A, it can form the antenna even with the planar embodiment, for example vehicle mark symbol on the tailgate or in the radiator grille.

The attachment elements or panelling elements 10A to 10E are preferably made, at least partially, of a non-conductive material, for example of plastic, rubber or glass. The antennas 6 are mounted here in or under the respective panelling element 10A to 10E so that they cannot be seen from the outside. Depending on the form and embodiment of the respective panelling element 10A to 10E, the respective antenna 6 is embodied as an antenna module, line structure or slot antenna. The non-conductive material is used here as a covering which is permeable to electromagnetic waves, as a carrier or as a dielectric of the antenna 6.

Furthermore, in FIG. 3, the antenna 6 is arranged in at least one cut-out 4B which is due to a joint. For this purpose, the cut-out 4B which is due to a joint or the joint is made correspondingly wide so that a sufficiently large installation space for the antennas 6 is provided. Towards the outside, a covering which is permeable to electromagnetic waves can be used to seal off the antennas 6. The cut-outs 4B which are due to a joint are, in particular, installation spaces at the joints or seams at which individual components of the vehicle outer skin 2 merge with one another. In particular the gap at the tailgate 12, the engine hood 14 and the doors 16 as well as the junctions at the front window or rear window 18, at the sunroof 20 and the junction between the roof 22 and side wall 24 at which a roof channel 26 is frequently provided, are used as the junctions or joints in the vehicle 1. Alternatively, or in addition, a slot which is made in the vehicle outer skin 2 or an opening which is formed can be used as what is referred to as a slot antenna at a joint, for example, at a gap or at the seam 26 between the roof 22 and the side wall 24. Said slot can then be protected, as appropriate, by a covering.

Furthermore, the openings which are provided in any case in the metallic outer skin, for example a slot opening in a brake light, in particular the additional, third brake light 28 or the ventilation opening 4A in the engine hood 8, can also be used as slot antennas. For this purpose, these openings which serve as antennas are appropriately geometrically dimensioned, arranged and supplied for a respective radio service to be implemented. The glass of the third brake light 28 or the plastic grille or ventilation opening 4A covers the respective slot antenna without a perceptible influence on the design of the vehicle 1. Alternatively, or in addition, antennas can be integrated in further light elements 30 which are arranged in the outer region of the vehicle 1. For example, lateral direction of travel indicators, or direction of travel indicators arranged in the outer mirror, can have a slot opening which serves as a slot antenna. Moreover, further lights, for example headlights 32, front and/or rear headlights which comprise reflectors made of non-metallic material, can serve to hold the antenna.

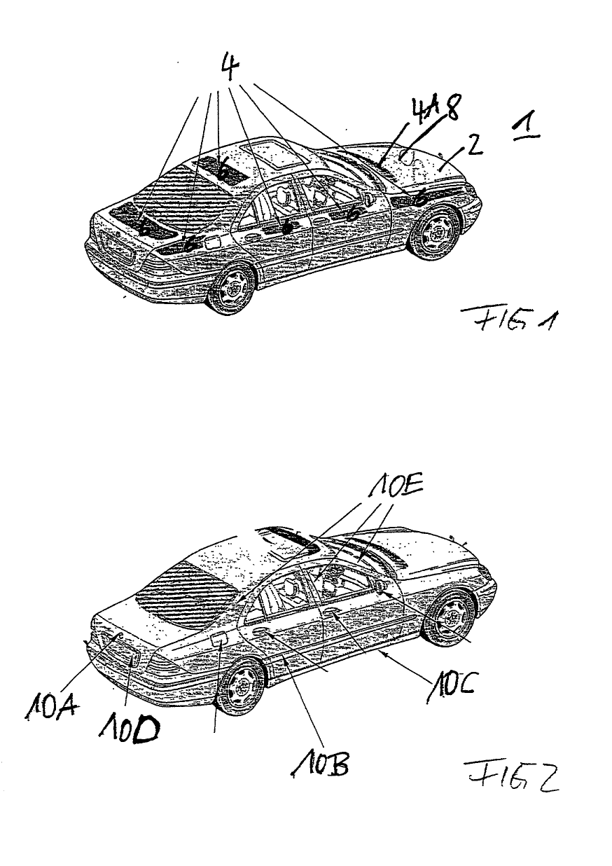

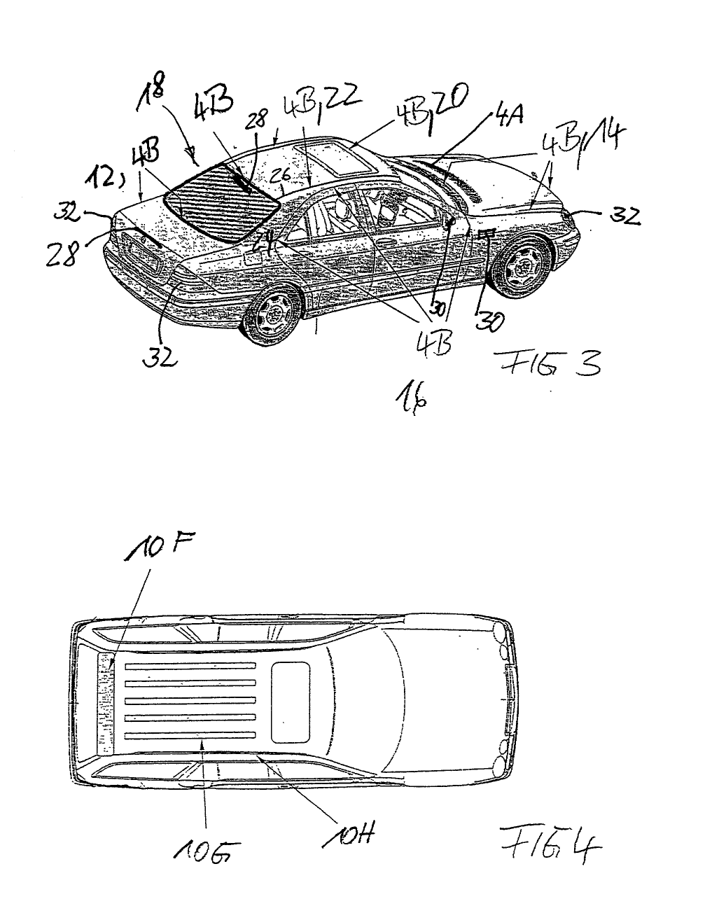

In FIG. 4, a spoiler 10F, carrier strips 10G of a luggage rack or roof rack 10H serve as a panelling element 10. Depending on the type and embodiment, these panelling elements 10F to 10H are formed from plastic, the antenna 6 being provided in or under them. The respective antenna 6 can be embodied here as an antenna module, as a slot antenna or as a line structure.

The advantages obtained with the invention consist, in particular, in the fact that the antennas 6 which are mounted in a break-through 4, in particular in an opening 4 which occurs for structural reasons on the vehicle outer skin 2, or in/under a covering in the break-through 4 or the vehicle outer skin 2 or bodywork outer skin 2 which is permeable to electromagnetic waves or in or under panelling elements 10, and are intended for different functions and frequencies, are not visible, or are visible only to a small degree, from the outside. This avoids the visual quality of the vehicle outer skin being degraded. Moreover, the installation locations are embodied by reference to technological, visual and functional preconditions for the use of a plurality of antennas with different functions and frequencies, in such a way that the antennas are decoupled as well as possible.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Antenna arrangement having a number of antennas for different functions and frequencies for a vehicle with a vehicle outer skin, wherein the antennas are arranged in structural cut-outs in at least one of the vehicle outer skin and in panelling elements which are mounted on the vehicle outer skin.

2. Antenna arrangement according to claim 1, wherein at least one of the antennas is arranged in a ventilation opening which is embodied as a cut-out.

3. Antenna arrangement according to claim 1, wherein at least one of the antennas is arranged in a cut-out due to a joint in a region of joints of the vehicle outer skin.

4. Antenna arrangement according to claim 2, wherein at least one of the antennas is arranged in a cut-out due to a joint in a region of joints of the vehicle outer skin.

5. Antenna arrangement according to claim 1, wherein the cut-out is formed by a slot in the vehicle outer skin, the slot being dimensioned in such a way that a slot antenna is formed.

6. Antenna arrangement according to claim 2, wherein the cut-out is formed by a slot in the vehicle outer skin, the slot being dimensioned in such a way that a slot antenna is formed.

7. Antenna arrangement according to claim 3, wherein the cut-out is formed by a slot in the vehicle outer skin, the slot being dimensioned in such a way that a slot antenna is formed.

8. Antenna arrangement according to claim 4, wherein the cut-out is formed by a slot in the vehicle outer skin, the slot being dimensioned in such a way that a slot antenna is formed.

9. Antenna arrangement according to claim 1, wherein
a panelling element is embodied as an element which is mounted on the vehicle outer skin in a planar fashion, and wherein at least one of the antennas is arranged in a structural cut-out in said panelling element.

10. Antenna arrangement according to claim 2, wherein
a panelling element is embodied as an element which is mounted on the vehicle outer skin in a planar fashion, and wherein at least one of the antennas is arranged in a structural cut-out in said panelling element.

11. Antenna arrangement according to claim 3, wherein
a panelling element is embodied as an element which is mounted on the vehicle outer skin in a planar fashion, and wherein at least one of the antennas is arranged in a structural cut-out in said panelling element.

12. Antenna arrangement according to claim 4, wherein
a panelling element is embodied as an element which is mounted on the vehicle outer skin in a planar fashion, and wherein at least one of the antennas is arranged in a structural cut-out in said panelling element.

13. Antenna arrangement according to claim 5, wherein
a panelling element is embodied as an element which is mounted on the vehicle outer skin in a planar fashion, and wherein at least one of the antennas is arranged in a structural cut-out in said panelling element.

14. Antenna arrangement according to claim 1, wherein at least one panelling element is formed a one of a decorative element and a ram bar or strip;
and wherein at least one of the antennae is arranged in a structural cut-out in said panelling element.

15. Antenna arrangement according to claim 2, wherein at least one panelling element is formed a one of a decorative element and a ram bar or strip;
and wherein at least one of the antennae is arranged in a structural cut-out in said panelling element.

16. Antenna arrangement according to claim 3, wherein at least one panelling element is formed a one of a decorative element and a ram bar or strip;
and wherein at least one of the antennae is arranged in a structural cut-out in said panelling element.

17. Antenna arrangement according to claim 4, wherein at least one panelling element is formed a one of a decorative element and a ram bar or strip;
and wherein at least one of the antennae is arranged in a structural cut-out in said panelling element.

18. Antenna arrangement according to claim 5, wherein at least one panelling element is formed a one of a decorative element and a ram bar or strip;
and wherein at least one of the antennae is arranged in a structural cut-out in said panelling element.

19. Antenna arrangement according to claim 9, wherein at least one panelling element is formed a one of a decorative element and a ram bar or strip;
and wherein at least one of the antennae is arranged in a structural cut-out in said panelling element.

20. Antenna arrangement according to one claim 1, wherein at least one antenna is formed by a panelling element itself.

21. Antenna arrangement according to one claim 2, wherein at least one antenna is formed by a panelling element itself.

22. Antenna arrangement according to one claim 3, wherein at least one antenna is formed by a panelling element itself.

23. Antenna arrangement according to one claim 4, wherein at least one antenna is formed by a panelling element itself.

24. Antenna arrangement according to one claim 5, wherein at least one antenna is formed by a panelling element itself.

25. Antenna arrangement according to one claim 9, wherein at least one antenna is formed by a panelling element itself.

26. Antenna arrangement according to one claim 14, wherein at least one antenna is formed by a panelling element itself.

27. A passenger vehicle comprising:
a vehicle outer skin,
panelling elements mounted on the vehicle outer skin, and
a plurality of antennas having respective different functions and frequency characteristics,
wherein the antennas are disposed at the vehicle outer skin and panelling elements in a manner which does not interfere with an outer appearance of the vehicle.

28. A passenger vehicle according to claim 27, wherein said antennaes includes antennas for:
(a) AM radio reception;
(b) FM radio reception; and
(c) a vehicle locking system

29. A passenger vehicle according to claim 28, wherein said antennas includes antennae for:
a GPS system.

30. A passenger vehicle according to claim 28, wherein said antennas includes antennae for:
a mobile telephone.

31. A passenger vehicle according to claim 28, wherein said antennas includes antennae for:
a satellite radio.

32. A passenger vehicle according to claim 28, wherein said antennas includes antennae for:
a distance determining radio system.

33. A method of making a passenger vehicle comprising:
placing a vehicle outer skin over a vehicle frame,
mounting panelling elements on the vehicle outer skin, and
installing a plurality of antennas having respective different functions and frequency characteristics,
wherein the installing of the antennas includes disposing the antennas at the vehicle outer skin and panelling elements in a manner which does not interfere with an outer appearance of the vehicle.

34. A method according to claim 33, wherein said antennaes includes antennas for:
(d) AM radio reception;
(e) FM radio reception; and
(f) a vehicle locking system

35. A method of making a passenger vehicle according to claim 33, wherein said installing includes forming at least one of said antennas as a slot antenna disposed in a joint between two parts of the outer skin.

36. A method of making a passenger vehicle according to claim 33, wherein said installing includes embedding at least one of said antennas in a respective panelling element.

37. A method of making a passenger vehicle according to claim 33, comprising sealing off an outwardly facing side of respective ones of said antennas with a cover which is permeable to electromagnetic waves operating on the antennas.
